(19) United States
(12) Patent Application Publication
(10) Pub. No.: US 2012/0161564 A1
(43) Pub. Date: Jun. 28, 2012

(54) Device and Method of Recycling Energy

(76) Inventors: Leng Khuong Lee, Long Beach, CA (US); Kimno Kuch Yem, Long Beach, CA (US)

(21) Appl. No.: 12/978,329

(22) Filed: Dec. 23, 2010

(51) Int. Cl. H02K 47/14; H02K 53/00

(52) U.S. Cl. 310/113; 74/DIG. 9

(57) ABSTRACT

The invention is a device for recycling energy comprising a battery, motor, and generator. The battery powers an electric motor, which in turn powers the generator, which simultaneously recharges the battery and powers external equipment. By recycling energy back into the device, the system is able to have continuously charged and available batteries. The batteries are depleted and recharged many times during their lifespan, but the batteries are never recharged by an external power source during the lifespan. The device requires no fuel or connection to an external power source.

### FIELD OF INVENTION

This invention generally relates to a device and method for recycling energy to allow a closed generator system to last longer. The device includes a battery, motor, and generator. The battery powers an electric motor, which in turn powers the generator, which then simultaneously re-charges the battery and powers external equipment. With this feedback loop, the system sustains itself, while at the same time powering an external device, and requires no fuel or connection to an external power source to recharge the batteries.

### BACKGROUND

An electrical generator is a device that converts mechanical energy to electrical energy. Portable or small electrical generators have been used for years to provide electricity to areas that are not connected to the electrical grid. Typically, a motor provides the mechanical energy in an electrical generator. The most common type of motor used in portable electrical generators is a gasoline or diesel fuel powered motor. Unfortunately, this requires the user of such generators to refuel the motor constantly.

Although battery operated generators, such as an electric car, exist, these generators require the generator to be connected to a power source, such as an electrical socket, in order to recharge the batteries. Thus, there is a need in the art for an electrical generator that is battery powered but does not need to be refueled or connected to an external source of electricity.

Similar to both the electric car and a gasoline powered electric generator is the hybrid car. First invented by Ferdinand Porsche in 1900, gasoline-electric hybrid engines widely became available in the late 1990s in cars like the Toyota Prius and Honda Insight. The motor is used to both power the car and also to drive a generator/recharging system. The generator/recharging system of the hybrid car recharges the battery and supplies electric power to such systems as interior and exterior car lights or various power outlets in the body of the car.

Although hybrid vehicles include rechargeable batteries, an engine, an electrical generator, and a recharger, they have a very complex system that is not efficient for use other than as a vehicle. Moreover, hybrid cars typically have an internal combustion engine or other liquid fuel powered engine, which require the continual addition of fuel to the engine. Examples of hybrid electric vehicles are disclosed in U.S. Pat. Nos. 4,351,405, issued to Fields, 5,910,722, issued to Lyons, 5,115,183, issued to Kyoukane, 5,780,980, issued to Naito, 5,786,640, issued to Sakai, and 4,602,694, issued to Weldin. These references generally disclose hybrid electric vehicles that include an interconnected system of batteries, a motor, and a recharging system, wherein the recharging system recharges the batteries from various sources. But, these references fail to disclose a system that operates without the need for fuel or being plugged into an external power source and it fails to disclose a recharging system wherein the batteries are recharged by the electrical generator.

Thus, there is a need in the art for an electrical generator device that is battery powered, long lasting, and does not require the addition of fuel or connection to an external power source.

### SUMMARY OF THE INVENTION

To minimize the limitations in the cited references, and to minimize other limitations that will become apparent upon reading and understanding the present specification, the present invention discloses a simplified method and device for recycling energy throughout batteries, a motor, and a generator. The battery powers an electric motor, which in turn powers the generator, which then simultaneously re-charges the battery and provides electrical power to equipment external to the recycled energy device. With this feedback loop, the system sustains itself while at the same time providing power externally. Importantly, the system never needs an external power source to power the system during its natural lifetime or the natural lifespan of the batteries. This allows the user to power equipment extraordinarily longer than would otherwise be achievable through the battery alone. The system does not otherwise require regular connection to an external source of power or fuel to be added. The life span of the invention is determined by the efficiency of the system and the type of battery. In the event that one or more of the batteries finally fails, after being depleted and recharged many, many times, the battery is simply replaced with a new fully-charged battery and the system starts anew.

One embodiment of the invention is a recycled energy device comprising: one or more motors; one or more batteries; one or more generators; one or more rechargers; and one or more switches. The batteries are connected to and power the motors. The motors are connected to and power the generators. The generators generate an electrical current, which is used to both recharge the batteries and power one or more external devices. The rechargers are connected to the batteries and to the generators. The generators provide the electrical current to the rechargers and the rechargers use the electrical current to recharge the batteries. The system typically has two sets of batteries. The first set provides power to the motors and the second set is recharged by the electric current. When the batteries providing power get low, the roles of the two sets of batteries are switched. This switching is preferably accomplished by the switches. The switches also preferably monitor the charge level of the batteries. The current generated is dependent upon the batteries, motor, and generator used. The larger the batteries and the more efficient the system, the more wattage that may be generated by the system. The voltage of the current is typically at the standard 120 V, but it may be at a higher voltage, including 220 V, 240 V, or even 440V. The batteries have a lifespan. The batteries are depleted and recharged a plurality of times during the lifespan. The batteries are never recharged by an external power source during the lifespan. The device is independent from any external power source and does not require fuel to power the motor.

Another embodiment of the invention is a method of recycling energy, the steps comprising: providing a recycled energy device; providing one or more batteries; providing one or more motors; providing one or more generators; connecting said one or more batteries to said one or more motors; powering said one or more motors by said one or more batteries; powering said one or more generators by said one or more motors; generating an electric current by said one or more generators; recycling said electric current by recharging said one or more batteries from said electric current; and powering an external device from said electric current. The method preferably includes the further steps of providing one or more rechargers; receiving by said one or more recharges said electric current from said one or more generators; recharging said one or more batteries by said one or more rechargers. Additionally, the batteries preferably include one or more batteries providing an electrical current to the motors and include one or more batteries that are being recharged and are not providing power to said one or more motors.

The method of recycling energy further comprises the steps of providing one or more switches; monitoring by said one or more switches a charge level of the batteries; switching by the switches which one or more batteries are recharged and which power the motors based on a low charge level of the batteries. Because a rechargeable battery lasts longer when it is depleted and then recharged, rather than being slowly depleted, the lifespan of the batteries might be extended beyond the normal lifespan of the batteries if those batteries were not part of the recycled energy device. The batteries are depleted and recharged a plurality of times during the lifespan of the batteries.

The recycled energy device is not recharged through an external power source and does not require an external fuel source. The motors are electric. The electric current generated by one or more generators may be provided at any voltage, including the standard 120 V to 240 V or even 220 V or 440 V.

In various embodiments of the invention, the generator simultaneously recharges the battery and powers external equipment. Electrical power may be converted and utilized through the system, but optical, thermal, mechanical, and other similar types of energy may also be used.

The batteries are replaced after they are no longer able to be recharged, which typically will not happen for several years, depending on the load pulled by the external equipment, the size and type of the batteries, and the efficiency of the system its component parts.

It is a purpose of this invention to provide an efficient, inexpensive, long lasting, easy to use, and off-the-grid power generator that recycles the chemical energy of the batteries and may make the batteries last longer than they would otherwise. Typically, a rechargeable battery will provide power for a short duration of time until it is depleted. At that point, the battery must be recharged through an external power source, such as a gas driven motor or a connection to a power grid or other supply. The rechargeable battery is able to be recharged and depleted many times before it will no longer hold a charge and is completely depleted. Unfortunately, this requires the user to have reccurring, frequent, and/or easy access to an external power source to recharge the batteries. The present invention allows a user to deplete and recharge the batteries the same number of times, or even more times, but does not require the user to connect the batteries to an external power source to recharge the batteries. Instead, the batteries are recharged by recycling the energy in the system, while at the same time providing power to external devices.

Moreover, the present invention allows the user to have a source of off-the-grid power that is quieter and lighter than a device that utilizes a gasoline generator. Indeed, the renewable energy device will never need recharging from an external source during its lifetime, whereas other inventions may need recharging from gasoline, electricity, or other sources that are external to that system. The only time a new source of energy is needed in the system is when the batteries will no longer recharge and they must be replaced. Depending on the amount of power used by the external devices, this might be well over several years.

Other features and advantages inherent in the produce washing method claimed and disclosed will become apparent to those skilled in the art from the following detailed description and its accompanying drawings.

### BRIEF DESCRIPTION OF THE DRAWINGS

FIG. 1 is a non-schematic, functional block diagram of one embodiment of the recycled energy device of the present invention.

FIG. 2 is a non-schematic, functional block diagram of one embodiment of the recycled energy device of the present invention and shows the recharger and switch.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope of the invention.

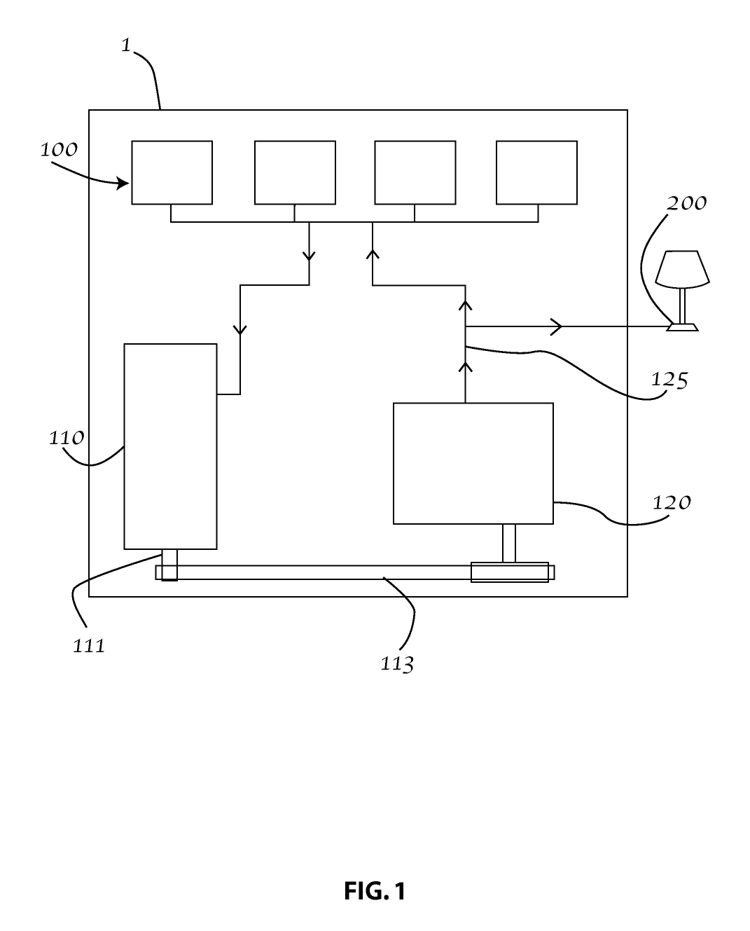

FIG. 1 is a non-schematic, functional block diagram of one embodiment of the recycled energy device of the present invention. FIG. 1 shows how the recycling energy device 1 preferably is comprised of batteries 100, motor 110, and generator 120. Although only one motor and generator are shown in FIG. 1, it should be understood that any number of motors and generators may make up the present invention without deviating from the scope of the invention. Additionally, although four batteries are shown in FIG. 1, it should be understood that the invention can work with any number of batteries.

FIG. 1 shows how the batteries 100 are connected to and power the motor 110. The motor, which is preferably a permanent magnet electric motor, turns a drive shaft 111 that is connected to generator 120 through belt 113. Alternatively, the motor can be an electromagnetic induction motor, or any type of motor that is powerable by a battery, such as a synchronous motor, asynchronous motor, or electric motor. As the drive shaft turns, the belt 113 powers generator 120. Although FIG. 1 shows that the generator is powered by a belt, any mechanism or device can be used to power the generator.

The generator 120 provides an electric current 125. The electric current is used to both power an external device 200 and recharge the batteries 100. In this manner, the batteries 100 can be charged without an external power source and will provide power until they are no longer able to be recharged. The generator can be any type or brand of electrical generator so long as it generates an electric current that can power an external device. Preferably, the generator will be able to provide a variety of voltages, including 120 V to 240 V, 220 V, and 440 V. The generator is preferably able to power a wide variety of external devices, such as, but not limited to: lights, radios, electrical appliances, heating and cooling units, computers, cell phone chargers, camping or tailgating equipment, and fans.

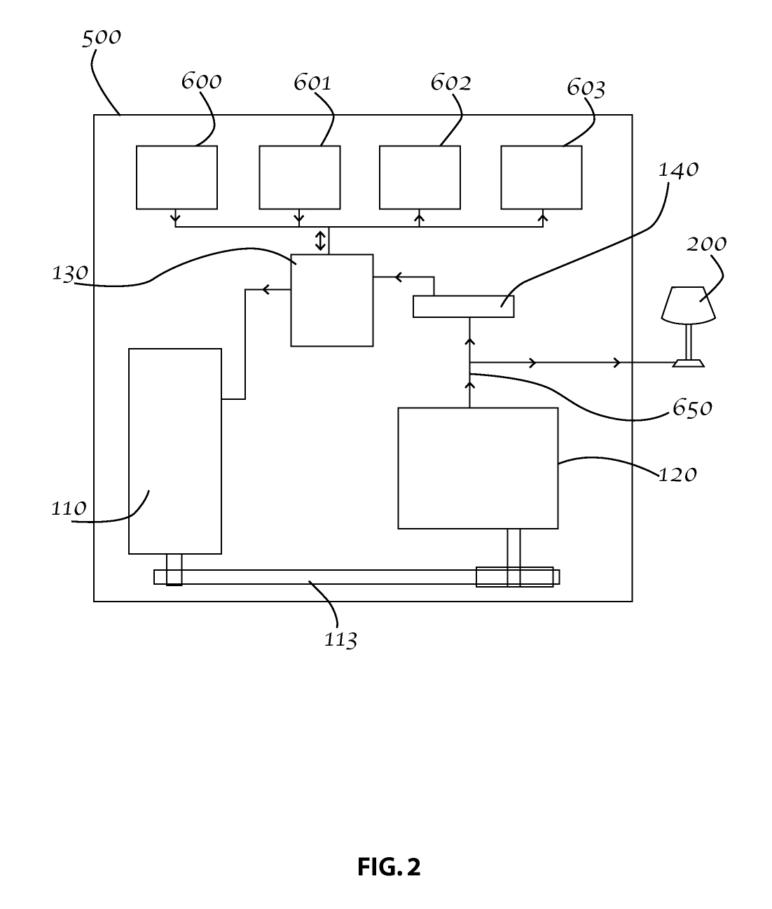

FIG. 2 is a non-schematic, functional block diagram of one embodiment of the recycled energy device of the present invention and shows the recharger and switch. FIG. 2 discloses that the recycling energy device 500, preferably comprises batteries 600, 601, 602, and 603, motor 110, generator 120, switch 130, recharger 140, and belt 113. FIG. 2 shows how the batteries 600 and 601 are powering the motor 110, which is powering generator 120 through the use of belt 113. The generator 120 produces an electric current 650, which powers an external device 200 and goes to recharger 140. The recharger takes the electric current and uses it to recharge batteries 602 and 603. The switch 130, which is connected to the batteries and the recharger, preferably monitors the charge levels in the batteries 600, 601, 602, and 603. When the charge level in batteries 600 and 601 drop to a low enough level, the switch switches the device 500 to draw power from batteries 602 and 603 and the recharger 140 starts to recharge batteries 600 and 601. In this manner, the device 500 is able to have recharged batteries ready to power the device once the batteries that previously provided power to the device are drained.

Although FIG. 1 shows that two batteries provide power while two batteries recharge, it should be understood that some batteries may be idle, any number of batteries may be used to power, and any number of batteries may recharge, without deviating from the scope of the invention. For example, one battery may provide power while one battery recharges, and two batteries are idle at a full charge. In another embodiment, the recycled energy device 500 has a switch that uses a timer to determine when to switch between batteries.

The recharger 140 is important to having an efficient recycled energy device 500 in one embodiment. The recharger 140, independent of the switch 130, preferably monitors the capacity of the batteries that it is recharging and it delivers the full-rated current when the battery is at low capacity. The voltage provided from the recharger 140 to the batteries is set to deliver the maximum current for the necessary period of time to minimize undue stress to the battery that can be caused by the battery cells heating up. This provides for the longest possible use of the system without recharging the batteries using an external source of power. When the battery nears full capacity, the recharger 140 preferably drops the recharging current and provides a float-charge to the battery to prevent self discharge of the cells of the battery.

The batteries 600, 601, 602, and 603, can be any rechargeable or secondary cell type battery. Several different combinations of chemicals may be used in the rechargeable batteries 600, 601, 602, and 603, including, but not limited to: lead-acid, nickel cadmium (NiCd), nickel metal hydride (NiMH), lithium ion (Li-ion), thin film, lithium sulfur, carbon foam, potassium ion, smart battery, and lithium ion polymer (Li-ion polymer).

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

We claim:

1. A recycled energy device comprising:
one or more motors;
one or more batteries; and
one or more generators;
wherein said one or more batteries are connected to and provide power to said one or more motors;
wherein said one or more motors are connected to and power said one or more generators;
wherein said one or more generators generate an electrical current;
wherein said electrical current is used to recharge said one or more batteries and power one or more external devices.

2. The recycled energy device of claim 1, further comprising:
one or more rechargers;
wherein said one or more rechargers are connected to said one or more batteries and to said one or more generators;
wherein said one or more generators provide said electrical current to said one or more rechargers and wherein said one or more rechargers use said electrical current to recharge said one or more batteries.

3. The recycled energy device of claim 1, wherein said one or more batteries include one or more batteries providing an electrical current to said one or more motors and include one or more batteries that are being recharged and are not providing power to said one or more motors.

4. The recycled energy device of claim 3, further comprising one or more switches;
wherein said one or more switches monitor a capacity of said one or more batteries and when said one or more batteries providing said electrical current to said one or more motors has a low charge level said one or more switches starts recharging said one or more low charge level batteries and causes said previous one or more recharging batteries to start proving said electrical current to said one or more motors.

5. The recycled energy device of claim 1, wherein said one or more motors are electric.

6. The recycled energy device of claim 1, wherein said electric current generated by one or more generators is at a voltage selected from the group consisting of 120 V, 220 V, 240 V, and 440 V.

7. The recycled energy device of claim 1, wherein said one or more batteries have a lifespan;
wherein said one or more batteries are depleted and recharged a plurality of times during said lifespan; and
wherein said batteries are never recharged by an external power source during said lifespan.

8. A recycled energy device comprising:
one or more motors;
one or more batteries;
one or more generators;
one or more rechargers; and
one or more switches;
wherein said one or more batteries are connected to and power to said one or more motors;
wherein said one or more motors are connected to and power said one or more generators;
wherein said one or more generators generate an electrical current;
wherein said electrical current is used to recharge said one or more batteries and power one or more external devices;
wherein said one or more rechargers are connected to said one or more batteries and to said one or more generators;
wherein said one or more generators provide said electrical current to said one or more rechargers and wherein said one or more rechargers use said electrical current to recharge said one or more batteries;
wherein said one or more batteries include one or more batteries providing an electrical energy to said one or more motors and include one or more batteries that are being recharged and are not providing power to said one or more motors;
wherein said one or more switches monitor a capacity of said one or more batteries and when said one or more batteries providing said electrical energy to said one or more motors has a low charge level said one or more switches starts recharging said one or more low charge level batteries and causes said previous one or more recharging batteries to start proving said electrical energy to said one or more motors;
wherein said one or more motors are electric;
wherein said electric current generated by one or more generators is at a voltage selected from the group consisting of 120 V, 220 V, 240 V, and 440 V;
wherein said one or more batteries have a lifespan;
wherein said one or more batteries are depleted and recharged a plurality of times during said lifespan; and
wherein said batteries are never recharged by an external power source during said lifespan.

9. A method of recycling energy, the steps comprising:
providing a recycled energy device;
providing one or more batteries;
providing one or more motors;
providing one or more generators;
connecting said one or more batteries to said one or more motors;
powering said one or more motors by said one or more batteries;
powering said one or more generators by said one or more motors;
generating an electric current by said one or more generators;
recycling said electric current by recharging said one or more batteries from said electric current; and
powering an external device from said electric current.

10. The method of recycling energy of claim 9, the steps further comprising:
providing one or more rechargers that receive said electric current from said one or more generators; and
recharging said one or more batteries by said one or more rechargers.

11. The method of recycling energy of claim 10, wherein said powering said one or more motors by said one or more batteries includes one or more batteries that are being recharged and are not providing power to said one or more motors.

12. The method of recycling energy of claim 11, the steps further comprising:
providing one or more switches;
monitoring by said one or more switches a charge level of said one or more batteries; and
switching by said one or more switches which one or more batteries are recharged and which power said one or more motors based on a low charge level of said one or more batteries.

13. The method of recycling energy of claim 12, wherein said one or more batteries have a lifespan;
wherein said one or more batteries are depleted and recharged a plurality of times during said lifespan; and
wherein said batteries are never recharged by an external power source during said lifespan.

14. The method of recycling energy of claim 12, wherein said one or more motors are electric.

15. The method of recycling energy of claim 12, wherein said electric current generated by one or more generators is at a voltage selected from the group consisting of 120 V, 220 V, 240 V, and 440 V.
